(19) United States
(12) Patent Application Publication
(10) Pub. No.: US 2023/0249252 A1
(43) Pub. Date: Aug. 10, 2023

(54) Metal Body Formed on a Component Carrier by Additive Manufacturing

(71) Applicant: AT&S Austria Technologie & Systemtechnik AG, Leoben (AT)

(72) Inventors: Marco Gavagnin, Leoben (AT); Jonathan Silvano de Sousa, Wien (AT)

(21) Appl. No.: 18/301,244

(22) Filed: Apr. 16, 2023

Related U.S. Application Data
(63) Continuation-in-part of application No. 16/152,659, filed on Oct. 5, 2018, now Pat. No. 11,659,648.

(30) Foreign Application Priority Data
Oct. 6, 2017 (EP) 17195322.7

(51) Int. Cl. B22F 10/28; B22F 10/47; B22F 10/64; B33Y 80/00; B33Y 10/00

(52) U.S. Cl. CPC B22F 10/28; B22F 10/47; B22F 10/64; B33Y 80/00; B33Y 10/00

(57) ABSTRACT

A component carrier includes a carrier body formed of a plurality of electrically conductive layer structures and/or electrically insulating layer structures, a metal surface structure coupled to the carrier body and a metal body directly on the metal surface structure formed by additive manufacturing. The metal body is arranged directly on the metal surface structure without material and layers in between.

### CROSS-REFERENCE TO RELATED APPLICATIONS

This application is a continuation-in-part application of U.S. patent application Ser. No. 16/152,659, filed on Oct. 5, 2018, and claims the benefit of the filing date of European Patent Application No. 17195322.7, filed Oct. 6, 2017, the disclosures of which are incorporated herein by reference in their entireties.

### TECHNICAL FIELD

Embodiments disclosed herein relate to a component carrier and to a method of manufacturing a component carrier, respectively.

### BACKGROUND ART

In electronic components, such as power devices and power LEDs, heat dissipation in circuitries of component carriers is of great importance due to the increasing power density per unit area of active components, both at the component carrier, e.g., a printed circuit board (PCB), and with respect to the packaging level. As an example, a widely used solution involves mounting a heat sink on the surface portion of the PCB or package which is needed to be cooled down. A heat sink is a passive heat exchanger that cools a device by dissipating heat into the surrounding medium.

For example, glue, epoxy, or adhesive tape, may be used for allowing a good adhesion of the heat sink to the PCB. However, the heat conductivity of an epoxy material or an adhesive tape is limited with respect to metal materials, such as aluminum or copper, which materials generally constitute the heat sink itself.

### SUMMARY

There may be a need to provide a component carrier having a proper thermal heat management and which can be manufactured efficiently.

A component carrier and a method of manufacturing a component carrier according to the independent claims are provided.

According to a first aspect of the disclosure a component carrier is presented. The component carrier comprises a carrier body formed of a plurality of electrically conductive layer structures and/or electrically insulating layer structures, a metal surface structure coupled to the layer structures and a metal body directly on the metal surface structure formed by additive manufacturing.

According to a further aspect of the invention, a method of manufacturing a component carrier is presented. A stack of a plurality of electrically conductive layer structures and/or electrically insulating layer structures are connected for forming a carrier body. A metal surface structure is formed on and/or coupled to the layer structures. A metal body is formed directly on the metal surface structure by additive manufacturing.

### OVERVIEW OF EMBODIMENTS

In the context of the present application, the term “component carrier” may particularly denote any support structure which is capable of accommodating one or more components thereon and/or therein for providing mechanical support and/or electrical connectivity. In other words, a component carrier may be configured as a mechanical and/or electronic carrier for components. In particular, a component carrier may be one of a printed circuit board (PCB), an organic interposer, and an IC (integrated circuit) substrate. A component carrier may also be a hybrid board combining different ones of the above-mentioned types of component carriers.

The component carrier comprises the carrier body having a stack of at least one electrically insulating layer structure and at least one electrically conductive layer structure. For example, the component carrier may be a laminate of the mentioned electrically insulating layer structure(s) and electrically conductive layer structure(s), in particular formed by applying mechanical pressure, if desired supported by thermal energy. The mentioned stack may provide a plate-shaped component carrier capable of providing a large mounting surface for further components and being nevertheless very thin and compact. The term “layer structure” may particularly denote a continuous layer, a patterned layer, or a plurality of non-consecutive islands within a common plane.

The metal surface structure forms a thermal and/or electrical connection to the metal body. The metal surface structure includes for example a metal foil, and in particular a copper foil. Furthermore, the metal surface structure may have a planar (i.e., uncurved), two-dimensional extension. However, the metal surface structure may also comprise complex three-dimensional structures, such as protrusions forming thermal and/or electrical connections. The metal surface structure may also be curved for being supported by respectively curved and flexible carrier bodies (such as flex PCBs). In an exemplary embodiment, the metal surface structure may be formed in or on the carrier body by additive manufacturing.

In the context of the present application, the term “additive manufacturing” may particularly denote a manufacturing procedure of the metal body according to which the metal body is manufactured by the sequential addition of portions of material which, when taken together, constitute the metal body. By such an additional manufacturing, stable and specifically thermal conductive formation of the metal body is possible without the need to glue the metal body to the metal surface structure and hence without the need of further intermediate adhesive layers and the like. Exemplary manufacturing processes for additive manufacturing are described in the following exemplary embodiments below. For example, 3D printing techniques, selective laser sintering (SLS), selective laser melting (SLM) and/or extra procedures can be applied for conducting additive manufacturing.

The component carrier may be completed (for instance by carrying out PCB manufacturing procedures) before a 3D print head is activated or controlled to form the metal body directly on the metal surface structure. Such a three-dimensional printing may be accomplished on the basis of printing material (such as a powder-based material) which is sintered or melted with the metal surface by, e.g., a spatially limited thermal treatment, applied by, for example, a laser. Moreover, it is also possible that the metal body is formed by ejecting droplets of melted printing material via a nozzle or the like, such as an extruder device or a plasma spray device, for forming layers of the metal body which are solidified after being applied to the metals surface structure or an already solidified layer of the metal body. Depending on the adoption of the additive manufacturing technique, each layer of the metal body may have a thickness of about 10 μm (Micrometer) to 50 μm for powder-based methods. However, it is possible to decrease the layer thickness (<1 μm) with other techniques such as ejecting melted metal droplets. The metal body may comprise a material selected of at least one of the group consisting of copper, aluminum, and steel.

In the context of the present document, the term “metal body” may particularly denote a structure formed by an additive manufacturing procedure. In particular, a three dimensionally printing as an additive manufacturing procedure comprises, for example, 3D printing with powder, 3D printing with melted materials, or 3D printing with fluid materials. 3D printing with powder may particularly denote the use of powder as printing material for the 3D printing. A further process using a printing material, e.g., in powder form is selective laser sintering/melting (SLS/SLM). Whether the process or act of “sintering” or “melting” depends on whether the delivered local energy is sintering or melting layers together. A further process using printing material in powder form is electron beam melting (EBM, or also called electron beam additive manufacturing EBAM). 3D printing by melting materials may particularly denote fused filament fabrication (FFF) or fused deposition modeling (FDM). Melted materials which will be used for this process may be in particular plastics like ABS or PLA. 3D printing by fluid materials may particularly denote a manufacturing process which uses a photosensitive fluid, such as fluidic UV-sensitive plastics (photopolymer). In particular, 3D printing with fluid materials may denote the so-called stereolithography (SLA). During this process the metal body is also formed layer by layer.

By deploying additive manufacturing, the metal body is directly formed on the metal surface structure. Hence, by using an additive manufacturing process, the metal body is arranged directly on the surface structure without the need for intermediate layers between the metal body and the metal surface structure. According to an exemplary embodiment, the metal body is arranged directly on the metal surface structure without material/layers in between. Furthermore, any combination of metals is possible, such as Cu/Cu (Copper/Copper) or Al/Cu (Aluminum/Copper) or Cu/Ni/Au (Copper/Nickel/Gold) etc.

Therefore, by the approach of the present disclosure, according to an exemplary embodiment, a proper thermal conductivity and/or electrical conductivity between the metal body and the metal surface structure and the carrier body, respectively, can be provided, because the metal body and the metal surface structure may be made of highly thermal and/or electrically conductive material. Specifically, the metal surface structure and the metal body may be made of similar or the same metal components such that no loss of thermal and/or electrical conductivity at the interface between the metal body and the metal surface structure is generated, for example due to the use of different materials between the metal surface structure and the metal body. For example, the metal surface structure and the metal body may consist of the same material such that an interface between the metal surface structure and the metal body is indistinguishable from each other.

For example, if the metal body should function as a heat sink, the heating is formed by the additive manufacturing on the component and the component carrier, respectively, itself, so that any heat resistive layers affecting the heat dissipation from the component are avoided. In other words, a metal-metal bond is provided between the heat sink and the metal surface on the PCB (component carrier), avoiding any glue, tape, or thermal interface material (TIM), so that it may be possible to enhance the heat conductivity of current available heat sink mount technologies of about 100 up to 300 times. The metal body may comprise a material selected of at least one of the group consisting of copper, aluminum, silver, nickel, bronze, gold, titanium, tantalum, wolfram, molybdenum and steel. Another point to be emphasized is the fact that an interface between the heat sink (metal body) and the metal surface structure can be provided in a continuous and homogenous manner so that no gaps or cavities are formed along the interface. For this reason, corrosion can be avoided and an efficient heat transport expected.

Furthermore, the additive manufacturing process for forming the metal body can be highly automated and no assembly of heat spreading structure is necessary since it is directly manufactured on the electronic component (PCB or package), implying lower manufacturing costs. Additive manufacturing allows the production of heat spreading structures with enhanced thermal conductivity controlled on the micro-structural level.

According to a further exemplary embodiment, the metal body comprises cooling fins wherein the cooling fins comprise for example a fractal geometry. The cooling fins can also have a perfuse form with one or more tubes or passages for guiding a moving fluid. Cooling fins form protrusions protruding from the surface of the metal body in order to increase the overall surface area of the metal body. Hence, the overall surface area provides a larger surface so that thermal energy can be efficiently transferred from the component carrier to the surrounding environment. Specifically, by additive manufacturing small and complex three-dimensional fin shapes can be manufactured.

According to a further exemplary embodiment, the metal body is a heat removal body, in particular one of a heat sink, a heat pipe, or a tube for forced water flow.

The metal body forming a heat sink may form a variety of designs due to the additive manufacturing. For example, the metal body may form a plurality of lamellas and the above-described cooling fins in order to increase the heat radiation surface of the metal body. Specifically, heat sinks with enhanced heat dissipation due to geometrical effects (fractal geometries), which are not easily realized with regular heat sink manufacturing methods can be formed directly on the PCB.

According to a further exemplary embodiment, the metal body functioning as a heat pipe comprises a tube extending at least partially along the metal surface structure. The metal body forming a heat pipe comprises an inner cavity forming, e.g., a tube-like shape within which an internal cooling fluid is flowable. The cooling fluid may be a gas or a liquid fluid. The heat pipe is a heat-transfer device that combines the principles of both thermal conductivity and phase transition to efficiently manage the transfer of heat between two solid interfaces, for example the metal surface structure on the one side and the environment of the metal body on the other side. At the hot interface of the heat pipe at the metal surface structure, the cooling fluid in contact with a thermally conductive solid surface (i.e., at the metal surface structure) turns into a vapor by absorbing heat from that surface. The vapor then travels along the heat pipe to the cold interface and condenses back into a liquid to thereby release latent heat. The liquid then returns to the hot interface by either capillary action, centrifugal force, or gravity, and the cycle repeats. Due to the very high heat transfer coefficients for boiling and condensation, heat pipes are highly effective thermal conductors.

According to a further exemplary embodiment, the tube surrounds at least partially a heat generating component. The heat generating component may be for example an electrical component as described below. Furthermore, the component may be for example a conductive line or another electrical guiding element. Hence, the tube forming a heat pipe may be formed in such a way, that the tube surrounds partially or completely the heat generating components. For example, the tube may have a ring shape, wherein the center of the ring the heat generating component is arranged. Furthermore, the tube may comprise a heat radiation section which is located spaced a certain distance from the component. The tube comprises an inner cavity through which a cooling fluid flows. Thereby, the tube forms a heat pipe, wherein the cooling fluid receives the thermal energy from the heat generating component and flows further to the heat radiation section of the tube, where the thermal energy is transferred from the cooling fluid to the environment in order to cool down the cooling fluid. Hence, the cooled cooling fluid flows back to the region partially surrounding the heat generating components for receiving again thermal energy from the heat generating component. Specifically, by additive manufacturing, the design of the tube may be flexible, such that the run and extension, respectively, of the tube along the component carrier may be individually adjusted. For example, the tube may extend in a meandering manner along the metal surface structure. For example, the tube may partially surround one or a plurality of heat generating components, such that the cooling fluid may pass more than one heat-generating component for cooling purposes. The same tube can be used for active cooling whereas both ends of the tube are open and connected to a closed circuit attached to a pump which is used to forcefully let a cooling fluid flow and cool the electronic device.

According to a further exemplary embodiment, the metal body comprises at least one locally roughened surface which has a higher roughness than other surfaces of the metal body for providing a heat exchange with a cooling medium. For example, by selecting a rest directive printing material for additive manufacturing having a larger particle size, a rough surface of the metal body may be formed. For example and more specifically, by using selective laser sintering/melting (SLS/SLM) a rough surface of the metal body can be formed. The result of a locally roughened surface is that the heat radiation capacity of the locally roughened surface is increased, so that by the locally roughened surface a higher heat transfer to the environment is provided then by the smoother and less rough surfaces of the metal body adjacent to the locally roughened surface. Hence, by forming locally roughened surface regions of higher heat transfer can be adjusted, so that the thermal management of the component carrier can be adjusted exactly.

According to a further exemplary embodiment, the metal surface structure and/or the metal body form an electrical contact element, in particular a contact pad, a contact line, or a plated area. For example, the metal body and/or the metal surface structure may form protrusions which function as an electrical contact.

According to a further exemplary embodiment, the metal body is formed within a contact hole of the carrier body, such that the metal body and the metal surface structure form an electrical contacting structure. For example, a contact hole may be formed by mechanical drilling or heat (laser) drilling in the carrier body. At a desired location inside the contact hole and/or the surface of the carrier body, the metal surface structure forming, e.g., the contact pad, is formed. Next, material suitable for being used with additive manufacturing techniques is filled into the contact hole and onto the metal surface structure by additive manufacturing. Hence, by additive manufacturing, the metal body forming an electrical connection can be formed directly onto a metal surface structure for providing proper electrical conductivity. By additive manufacturing, complex structures of the metal body onto or within the metal body may be formed. Hence, by additive manufacturing, vias and/or contact layers having complex three-dimensional designs can be formed within or onto the carrier body.

Hence, the via present in the carrier body (e.g., the PCB) can be fabricated using additive manufacturing, such as by SLM/SLS, by either filling pre-formed holes with, e.g., conductive powder (copper Cu, silver Ag, Steel, titanium Ti, gold Au, etc.) for forming the metal body which will be then melted, or using the laser used, e.g., in SLM/SLS machines to produce the hole through the carrier body and melt the material/powder bed on top of the PCB at the same time which will fill the hole. According to embodiments of the disclosure, the laser device in SLM/SLS machines can be first used to produce holes and then fill the hole with the powder and subsequently melting and solidifying the conductive powder. The via formation/filling processes described above can be used in any kind of PCB as an alternative to conventional manufacturing techniques, i.e., mechanical/laser drilling, providing an electro-less seed layer, galvanic plating via filling. An advantage is the possibility of mixing different metal combinations in the same PCB such as Al/Cu, Ti/Cu or steel/Cu. Another advantage of the process is to spare cleaning processes (smearing) that are needed in the production of proper PCB through-vias. The smearing process may be needed to prepare the hole properly before galvanization. New generations of materials, such as materials designed for 5G communication standards, present low polarization and this affects the smearing processes efficiency. Directly filling the PCB vias with additive processes such as SLM will revoke the need for smearing processes.

According to a further exemplary embodiment, the carrier body comprises a through hole between a first body surface and a second body surface of the carrier body, wherein the metal surface structure is formed within the through hole such that a first surface of the metal surface structure is accessible, in particular for an electronic component, and a second surface of the metal surface structure opposite to the first surface is in contact with the metal body. Hence, by the described design of the component carrier, a proper heat conduction between two opposing carrier body surfaces is provided. Hence, while on the one carrier body surface active or passive heat generating components are mounted, metal bodies functioning as a heat sink or a heat pipe may be formed by additive manufacturing at the opposed carrier body surface. The metal surface structure functions as a heat guidance through the carrier body. Thereby, between the heat generating components and the metal body, no further layers (e.g., adhesive layers), reducing the thermal conductivity, need to be applied.

According to a further exemplary embodiment, the component carrier comprises a component, in particular an electronic component, mounted on and/or embedded in the carrier body, wherein the component is in particular thermally coupled via the metal surface structure to the metal body. The metal surface structure connecting the embedded component and the heat sink can be every kind of via type (plated through holes, blind vias, μ-vias, etc.) or can be fabricated directly via additive manufacturing, such as by SLM or SLS.

According to a further exemplary embodiment, the electrical component is attached to a carrier body surface. The metal surface structure is formed between the carrier body surface and the electrical component for providing a thermal connection.

According to a further exemplary embodiment, the carrier body surface comprises a receiving recess within which an electrical component is arranged. The receiving recess may be formed by etching or by mechanical drilling/milling.

According to a further exemplary embodiment, the metal surface structure is formed by a metal surface of the component. Hence, the component may comprise for example a thermally conductive casing or (thermal and/or electrical) contact area, such as metal contact or a metal casing. A part of the surface of the component is accessible from the environment, so that the metal body may be directly formed by additive manufacturing on the part of the surface of the component.

According to a further exemplary embodiment, the component is embedded in the carrier body and is thermally coupled via the metal surface structure to the metal body.

According to a further exemplary embodiment, the carrier body comprises an internal receiving cavity into which the component is embedded. At least one of the plurality of electrically conductive layer structures and/or electrically insulating layer structures is arranged between a surface of the metal body and the receiving cavity. The at least one thermal channel is formed in at least one of the plurality of electrically conductive layer structures and/or electrically insulating layer structures between the receiving cavity and the surface of the metal body arranged on a surface of the carrier body. The at least one thermal channel is filled with at least a part of the metal surface structure. The thermal channels may be formed by etching or by mechanical/laser drilling.

According to a further exemplary embodiment, the metal body is configured as a component. In this context, the metal body may be an active component (e.g., a microelectromechanical system, MEMS) or a passive component (e.g., a heat sink, an antenna, a (magnetic) inductor, a capacitor, an electrical resistance).

According to an exemplary embodiment, the component carrier comprises: i) a carrier body formed of a plurality of electrically conductive layer structures and/or electrically insulating layer structures; ii) a metal surface structure coupled to the layer structures; and iii) a metal body directly on the metal surface structure formed by additive manufacturing, wherein the metal body is arranged directly on the metal surface structure without material and layers in between.

This feature, in particular the arrangement of the metal body directly on the metal surface structure without material and layers in between, allows for an efficient dissipation of the heat from the component and thereby improves the performance and reliability of the component.

According to a further exemplary embodiment, the metal body is formed by 3D-printing as the additive manufacturing. A complex geometry of the metal body may be formed by additive manufacturing in a precise manner and with less waste than traditional manufacturing methods.

According to a further exemplary embodiment, the metal body is formed by 3D-printing as a layer-by-layer additive manufacturing. Thus, the different layers from the additive manufacturing process can be seen in the final product. In other words, the layers in the final product reflect the additive manufacturing process. The metal body formed by a 3D printing layer-by-layer additive manufacturing is unequivocally recognizable as being formed by this technology and is distinguishable from products done with other technologies/processes. The layer-by-layer structure is composed of melted material deposited on a base and then on the highest layer, resulting in the lateral imperfections of the layer-by-layer structure being unequivocally recognizable as manufactured by a 3D printing process. Thereby, several types of additive manufacturing including but not restricted to Fused Deposition Modeling (FDM), Stereolithography (SLA), Selective Laser Sintering (SLS) may be used.

According to a further exemplary embodiment, the metal body is configured as a heat transfer body. Thus, the metal body may dissipate heat from the component, thereby reducing any risk of overheating and damage and increasing component lifetime. This may be advantageous in terms of controlling the distribution of heat in a component carrier.

According to a further exemplary embodiment, the metal body is configured as a heat sink and is arranged directly on the metal surface structure without material and layers in between. Placement of the heat sink directly on the metal structure may be advantageous in terms of efficient dissipation of the heat from the component and thereby improving the performance and reliability of the component.

According to a further exemplary embodiment, an interface between the heat sink and the metal surface structure as provided is continuous and homogeneous, so that no gaps or cavities are formed along the interface. In this respect, a better connection between the heat sink and the metal surface structure may be ensured allowing the heat dissipation to be performed in a more efficient manner.

According to a further exemplary embodiment, the at least one component can be selected from a group consisting of an electrically non-conductive inlay, an electrically conductive inlay (such as a metal inlay, preferably comprising copper or aluminum), a heat transfer unit (for example a heat pipe), a light guiding element (for example an optical waveguide or a light conductor connection), an electronic component, or combinations thereof. For example, the component can be an active electronic component, a passive electronic component, an electronic chip, a storage device (for instance a DRAM or another data memory), a filter, an integrated circuit, a signal processing component, a power management component, an optoelectronic interface element, a voltage converter (for example a DC/DC converter or an AC/DC converter), a cryptographic component, a transmitter and/or receiver, an electromechanical transducer, a sensor, an actuator, a microelectromechanical system (MEMS), a microprocessor, a capacitor, a resistor, an inductance, a battery, a switch, a camera, an antenna, a logic chip, and an energy harvesting unit. However, other components may be embedded in the component carrier. For example, a magnetic element can be used as a component. Such a magnetic element may be a permanent magnetic element (such as a ferromagnetic element, an antiferromagnetic element or a ferrimagnetic element, for instance a ferrite core) or may be a paramagnetic element. However, the component may also be a further component carrier, for example in a board-in-board configuration. The component may be surface mounted on the component carrier and/or may be embedded in an interior thereof. Moreover, other components, in particular those which generate and emit electromagnetic radiation and/or are sensitive with regard to electromagnetic radiation propagating from an environment, may be used as a component.

In an embodiment, the at least one electrically insulating layer structure comprises at least one of the group consisting of resin (such as reinforced or non-reinforced resins, for instance epoxy resin or Bismaleimide-Triazine resin, more specifically FR-4 or FR-5), cyanate ester, polyphenylene derivate, glass (in particular glass fibers, multi-layer glass, glass-like materials), prepreg material, polyimide, polyamide, liquid crystal polymer (LCP), epoxy-based Build-Up Film, polytetrafluoroethylene (Teflon®), a ceramic, and a metal oxide. Teflon® is a registered mark of The Chemours Company FC LLC of Wilmington, Del., U.S.A. Reinforcing materials such as webs, fibers, or spheres, for example made of glass (multilayer glass) may be used as well. Although prepreg or FR4 are usually preferred, other materials may be used as well. For high frequency applications, high-frequency materials such as polytetrafluoroethylene, liquid crystal polymer and/or cyanate ester resins may be implemented in the component carrier as an electrically insulating layer structure.

In an embodiment, the at least one electrically conductive layer structure comprises at least one of the group consisting of copper, aluminum, nickel, silver, gold, palladium, and tungsten. Although copper is usually preferred, other materials or coated versions thereof are possible as well, in particular materials coated with supra-conductive material such as graphene.

According to an exemplary embodiment, the component carrier is shaped as a plate. This contributes to the compact design, wherein the component carrier nevertheless provides a large basis for mounting components thereon. Furthermore, in particular a naked die as example for an embedded electronic component, can be conveniently embedded, thanks to its small thickness, into a thin plate such as a printed circuit board.

According to an exemplary embodiment, the component carrier is configured as one of the group consisting of a printed circuit board, and a substrate (in particular an IC substrate). In the context of the present application, the term “printed circuit board” (PCB) may particularly denote a component carrier (which may be plate-shaped (i.e., planar), three-dimensionally curved (for instance when manufactured using 3D printing) or which may have any other shape) which is formed by laminating several electrically conductive layer structures with several electrically insulating layer structures, for instance by applying pressure, if desired accompanied by the supply of thermal energy. As preferred materials for PCB technology, the electrically conductive layer structures are made of copper, whereas the electrically insulating layer structures may comprise resin and/or glass fibers, so-called prepreg or FR4 material. The various electrically conductive layer structures may be connected to one another in a desired way by forming through-holes through the laminate, for instance by laser drilling or mechanical drilling, and by filling them with electrically conductive material (in particular copper), thereby forming vias as through-hole connections. Apart from one or more components which may be embedded in a printed circuit board, a printed circuit board is usually configured for accommodating one or more components on one or both opposing surfaces of the plate-shaped printed circuit board. They may be connected to the respective main surface by soldering. A dielectric part of a PCB may be composed of resin with reinforcing fibers (such as glass fibers).

In the context of the present application, the term “substrate” may particularly denote a small component carrier having substantially the same size as a component (in particular an electronic component) to be mounted thereon. More specifically, a substrate can be understood as a carrier for electrical connections or electrical networks as well as component carrier comparable to a printed circuit board (PCB), however with a considerably higher density of laterally and/or vertically arranged connections. Lateral connections are for example conductive paths, whereas vertical connections may be for example drill holes. These lateral and/or vertical connections are arranged within the substrate and can be used to provide electrical and/or mechanical connections of housed components or unhoused components (such as bare dies), particularly of IC chips, with a printed circuit board or intermediate printed circuit board. Thus, the term “substrate” also includes “IC substrates”. A dielectric part of a substrate may be composed of resin with reinforcing spheres (such as glass spheres).

In an embodiment, the component carrier is a laminate-type component carrier. In such an embodiment, the component carrier is a compound of multiple layer structures which are stacked and connected together by applying a pressing force, the pressing force may be accompanied by heat.

According to an exemplary embodiment of the method, the additive manufacturing comprises applying a printing material to an application device, melting the printing material in the application device, and applying the melted printing material on the metal surface structure for forming at least on layer of the metal body. The application device may be for example the printer head functioning as, e.g., an extruder device comprising a heater for melting the printing material and an ejection element, such as a nozzle, for ejecting the melted printing material in form of droplets or thin melted material beams to the desired location at the metal surface structure.

For example, the application device may form the metal body layer by layer. A thickness of a layer may be around 50 μm. During the manufacturing process, more than one application device may be used and different materials may be applied for simultaneously manufacturing more than one metal body. The used meltable material may be made of an electrically conductive material, e.g., copper, or it may be enriched with electrically conductive material compounds. The printing material may be for example a powder material or granulate.

According to a further exemplary embodiment of the method, the additive manufacturing comprises applying a printing (powder or granulate) material on the metal surface structure and consolidating (i.e., solidifying/hardening) the applied printing material by, e.g., sintering or melting using a thermal treatment device, in particular by a laser device, for forming at least one layer of the metal body. The term “consolidating” may particularly denote any step or activity for bringing the printed material in a solid state, wherein the solid state is the state of at least one layer structure made of the printing material. For example, consolidating may be at least one of the following: adhering, gluing, curing, tempering, solidifying, or melting and subsequently hardening of the printing material.

According to a further exemplary embodiment of the method, the metal body may be formed by at least one of the group consisting of selective laser melting (SLM), selective laser sintering (SLS), electron beam melting (EBM), and electron beam additive manufacturing EBAM).

According to a further exemplary embodiment of the method, before consolidating the printing material, the printing material is melted by a thermal treatment device, in particular a laser device. The single layers of the metal body are melted or sintered by means of a thermal treatment device, such as a laser, which is called selective laser sintering (SLS) or selective laser melting (SLM). Hence, metals, ceramics and sand may be used for SLS or SLM. If the SLS or SLM method is used for manufacturing, the forming of the layer of the powder material is performed by means of a laser, wherein the laser melts or sinters the powder material for forming at least one layer of the metal body. When using SLM or SLM manufacturing methods an adhesive or adhesive layer for forming the metal body may be obsolete.

Further, the powder may be melted by the use of a controllable electron beam, which will be called electron beam melting (EBM). This manufacturing process may allow use of materials comprising a higher melting point, e.g., for melting titanium-based materials.

According to a further exemplary embodiment of the method, the printing material is applied by a material (e.g., powder) delivery nozzle. Hence, a printer head may comprise the material delivery nozzle. The printer head may further comprise a material storage which contains the printing material. The printer head may control the amount of printing material delivered by the nozzle to the desired location.

According to a further exemplary embodiment, the method may include moving the material delivery nozzle for forming the layer or a further layer of the metal body. Specifically, the printer head comprising the delivery nozzle may be movable along two or along three spatial directions so that the application location of the printing material onto the metal surface structure may be adjusted and additionally the distance between the material delivery nozzle and the metal surface structure may be adjusted.

According to a further exemplary embodiment, before the printing material is applied on the metal surface structure, the carrier body is provided into a material (i.e., powder) bed. The carrier body may be adjusted in registration with the material bed such that the metal surface structure, which is formed on or in the carrier body is arranged with a defined distance to a surface of the material bed. Hence, between the environment and the metal surface structure, a desired thickness of printing material is arranged. Next, by a treatment device as described below, which may be a thermal treatment device for applying thermal energy to the metal surface structure or for radiating (e.g., by an ultraviolet laser) a predefined wavelength of light for photopolymerization to the metal surface structure, solidifies the applied printing material between the surface of the material bed and the metallic surface structure. According to an exemplary embodiment a fluid material, e.g., a photosensitive material is provided. This process may also be used with mixed materials such as ceramic, metallic and photopolymer mixtures. During this process also more than one laser may be used. In particular, the fluid material may be photosensitive under the ultraviolet light of the laser. A further process using fluidic materials may be the multi-jet modelling, poly jet method. In this process of fluidic light-sensitive plastic is applied onto a platform by a print-head and is immediately cured by a light source (e.g., a laser) integrated in the print-head (e.g., the laser device).

According to a further exemplary embodiment, the method comprises moving the carrier body for forming a further layer of the metal body. In particular, after solidifying a first layer the metal body, the carrier body may be moved, in particular may be lowered, such that a further layer of printing material is arranged between the solidified first layer of the metal body and the surface of the material bed. Next, the further powder layer may be solidified by the treatment device.

According to a further exemplary embodiment of the method, the carrier body is arranged in a container. According to this exemplary embodiment, the additive manufacturing comprises providing a solidifiable fluid material in the container, solidifying the fluid material by a treatment device, in particular a laser device, on the metal surface for forming at least one layer of the metal body. The present exemplary embodiment functions similar to the described embodiment above using the powder material. The carrier body may be adjusted in the container such that the metal surface structure, which is formed on or in the carrier body is arranged with a defined distance to a surface of the solidifiable (e.g., liquid) fluid material. Hence, between the environment and the metal surface structure, a desired thickness of fluid material is positioned. Next, by a treatment device for applying thermal energy to the metal surface structure or for radiating a predefined wavelength of light for photopolymerization to the metal surface structure, solidifies the fluid between the surface of the powder bed and the metallic surface structure.

In particular, after solidifying a first layer the metal body, the carrier body may be moved in the container, in particular may be lowered, such that a further layer of solidifiable fluid is arranged between the solidified first layer of the metal body and the surface of the solidifiable fluid. Next, the further fluid layer may be solidified by the treatment device.

Hence, according to the exemplary embodiments of the method described above, by selective laser sintering/melting (SLS/SLM) as additive manufacturing of the metal body (e.g., the heat sink) on the metal surface structure (such as on aluminum or copper inlays of the carrier body) which have been previously integrated into the carrier body (i.e., the PCB). Alternatively, a package with the metal surface structure may also be used as a base from where to start the additive manufacturing the metal body, functioning for example as a heat sink. SLS/SLM is a process based on the local sintering/melting of a powder bed or solidifiable fluid material, supplied either layer by layer (e.g., if the carrier body is arranged within a powder bed or a container comprising the carrier body as described above) or by locally delivering the material where needed, e.g., by a printer head as described above. The resolution of the features realized by SLS and SLM is related to both the powder particle size and the laser spot diameter, i.e., the smaller the grains and laser spot the finer will be the minimum feature size. However, finer particle dimensions imply a higher reactivity of the powder (mainly oxidation in the case of metals) at atmospheric conditions.

The printing (powder) material and/or the solidifiable fluid material may consist of components of metal material (e.g., aluminum Al, silver Ag, titanium Ti, bronze, steel, nickel Ni, copper Cu, copper-chrom Co—Cr, gold Au, tantalum Ta, wolfram W, molybdenum Mo and respective alloys thereof), thermoplastics (e.g., Nylon, Polyamide, Polystyrene), Elastomers, Composites and or FR materials.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless otherwise noted, in addition to any combination of features belonging to one type of subject matter also any combination between features relating to different subject matters, in particular between features of the apparatus type claims and features of the method type claims is considered as to be disclosed with this document.

The aspects defined herein and further aspects of the disclosure are apparent from the illustrated examples to be described hereinafter and are explained with reference to these illustrated examples.

### BRIEF DESCRIPTION OF THE DRAWINGS

FIG. 1, FIG. 2, FIG. 3, and FIG. 4 respectively show component carriers comprising metal bodies forming a heat sink according to exemplary embodiments of the present disclosure.

FIG. 5, FIG. 6, and FIG. 7 show a method of forming a component carrier comprising an electrical contact structure according to an exemplary embodiment of the disclosure.

FIG. 8, FIG. 9, and FIG. 10 show a method of forming a component carrier comprising an electrical contact structure according to an exemplary embodiment of the disclosure.

FIG. 11 shows a schematic view of a metal body formed as a heat pipe according to an exemplary embodiment of the present disclosure.

FIG. 12 shows a schematic view of a manufacturing tool for forming a component carrier according to an exemplary embodiment of the present disclosure.

FIG. 13 shows a schematic view of a manufacturing tool for forming a component carrier according to an exemplary embodiment of the present disclosure.

FIG. 14 shows a schematic view of layers of a metal body formed by a 3D additive manufacturing process according to an exemplary embodiment of the present disclosure.

### DETAILED DESCRIPTION OF ILLUSTRATED EMBODIMENTS

The illustrations in the drawings are schematically presented. In different drawings, similar or identical elements are provided with the same reference signs.

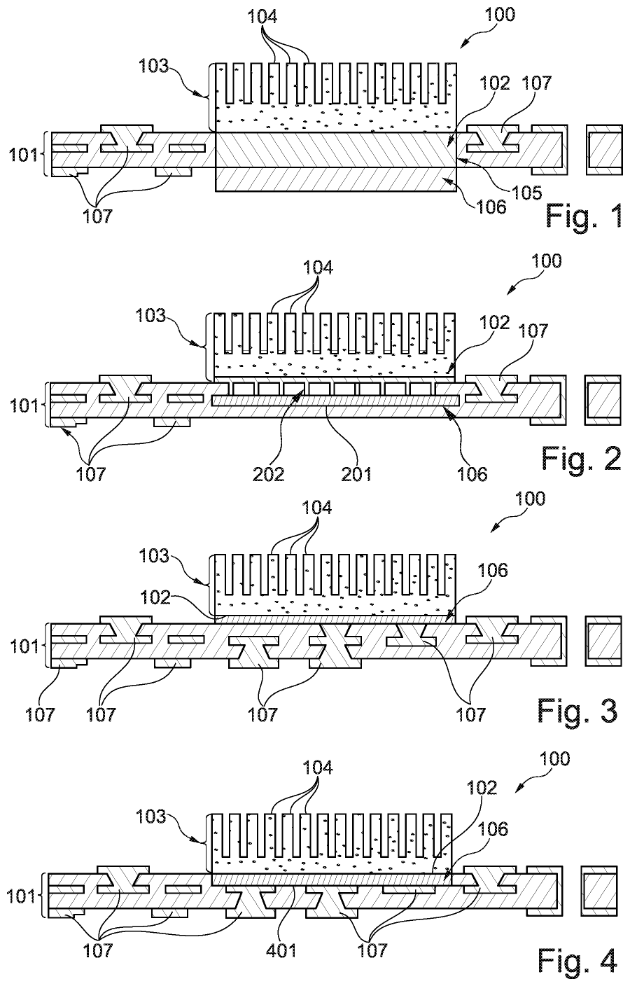

FIG. 1 shows a component carrier 100 comprising a metal body 103 forming in particular a heat sink according to an exemplary embodiment of the present invention. The component carrier 100 comprises a carrier body 101 formed of a plurality of electrically conductive layer structures and/or electrically insulating layer structures, a metal surface structure 102 on the layer structures and the metal body 103 which is formed directly on the metal surface structure 102 by additive manufacturing.

A stack of the plurality of electrically conductive layer structures and/or electrically insulating layer structures are connected for forming the carrier body 101. The metal surface structure 102 is formed on or in the layer structures. The metal body 103 is formed directly on the metal surface structure 102 by additive manufacturing. For example, the carrier body 101 may be a laminate of the mentioned electrically insulating layer structure(s) and electrically conductive layer structure(s), in particular formed by applying mechanical pressure, if desired supported by thermal energy.

Furthermore, within the carrier body 101 or formed on a surface of the carrier body 101 contacting lines/pads 107 are formed. The contacting lines/pads 107 form an electrical connection with the component 106 or other devices.

The metal surface structure 102 forms a thermal coupling to the metal body 103. The carrier body 101 comprises a through-hole 105 between a first body surface and a second body surface of the carrier body 101. The metal surface structure 102 is formed within the through-hole 105 such that a first surface of the metal surface structure is accessible, in particular for an electronic component 106. A second surface of the metal surface structure 102 opposite to the first surface is in contact with the metal body 103. Hence, by the described design of the component carrier in FIG. 1, a proper heat conduction between two opposing carrier body surfaces is provided. Hence, while on the one carrier body surface active or passive heat generating components 105 are mounted, metal bodies 103 functioning as a heat sink or a heat pipe may be formed by additive manufacturing at the opposed carrier body surface. The metal surface structure 102 functions as a heat guidance through the carrier body 101. Thereby, between the heat generating components 106 and the metal body 103, no further layers (e.g., adhesive layers), reducing the thermal conductivity, need to be applied. Through hole 105 may be formed by mechanical/laser drilling or by etching.

The metal body 103 is formed on the metal surface structure 102 by additive manufacturing, without the need of further intermediate adhesive layers between the metal body 103 itself and the metal surface structure 102.

The metal body 103 comprises cooling fins 104. Cooling fins 104 form protrusions protruding from the surface of the metal body 103 in order to increase the overall surface area of the metal body 103. Hence, the overall surface area provides a larger radiation surface, so that the thermal conductivity with the environment of the component carrier 100 can be improved.

FIG. 2 shows a further exemplary embodiment of a component carrier 100 comprising a metal body 103 functioning as a heat sink. The component 106 is embedded in the carrier body 101 and being thermally coupled via the metal surface structure 102 to the metal body 103.

The carrier body 101 comprises an internal receiving cavity 201 into which the component 106 is embedded. At least one of the plurality of electrically conductive layer structures and/or electrically insulating layer structures, forming an intermediate layer structure, is arranged between a surface of the metal body 103 and the receiving cavity 201. Thermal channels 202 are formed in the intermediate layer structures between the receiving cavity 201 and the surface of the metal body 103 arranged on a surface of the carrier body 101. The at least one thermal channel is filled with the metal surface structure 102. The thermal channels 202 may be formed by etching or by mechanical/laser drilling of the intermediate layer structure.

FIG. 3 shows a further exemplary embodiment of a component carrier 100 comprising a metal body 103 functioning as a heat sink. The component 106 is arranged on a carrier body surface. The metal surface structure 102 is formed by a metal surface of the component 106. Hence, the component 106 may comprise, for example, a thermally conductive casing or (thermal and/or electrical) contact area, such as metal contact or a metal casing. The part of the surface of the component 106 is accessible from the environment, so that the metal body 103 is directly formed by additive manufacturing on the part of the surface of the component 106.

FIG. 4 shows a further exemplary embodiment of a component carrier 100 comprising a metal body 103 functioning as a heat sink. The carrier body 101 and its surface, respectively, comprises a receiving recess 401 within the electrical component 106 is arranged. The receiving recess 401 may be formed by etching or by mechanical drilling/milling.

FIG. 5 to FIG. 7 show schematic views of a method of forming a component carrier 100 comprising an electrical contact structure 701 according to an exemplary embodiment of the present invention. Accordingly, the metal surface structure 102 forms an electrical contact element or structure 701, in particular a contact pad, a contact line, or a plated area. The metal body 103 is formed within a contact hole 501 of the carrier body 101, such that the metal body 103 and the metal surface structure 102 forms the electrical contacting structure 701.

The contact hole 501 is formed by mechanical drilling or by etching in the carrier body 101. Furthermore, the metal surface structure 102 is arranged on a carrier body surface or embedded within the carrier body 101. As can be seen from FIG. 5, the metal surface structure 102 covers the hole 501. Next, printing material (i.e., powder material) 502 suitable for being used with additive manufacturing techniques is filled into the contact hole 501 and onto the metal surface structure 102.

Next, as can be taken from FIG. 6, additive manufacturing procedures are applied. Accordingly, a treatment device generates a laser beam 503 for melting or sintering the printing material 502. In FIG. 7 it is shown, that after applying the laser beam 503 and hence solidifying the printing material 502, a metal body 103 fills the hole 501 such that a surface of the metal body provides an electrical contact structure 701.

Hence, the via present in the carrier body 101 (e.g., the PCB) can be fabricated using additive manufacturing, such as SLM/SLS, by filling pre-formed holes 501 with, e.g., conductive powder 502 (Cu, Si, Ag, Steel, Ti, Au, etc.) for forming the metal body 103 which will be then melted by the laser beam 503.

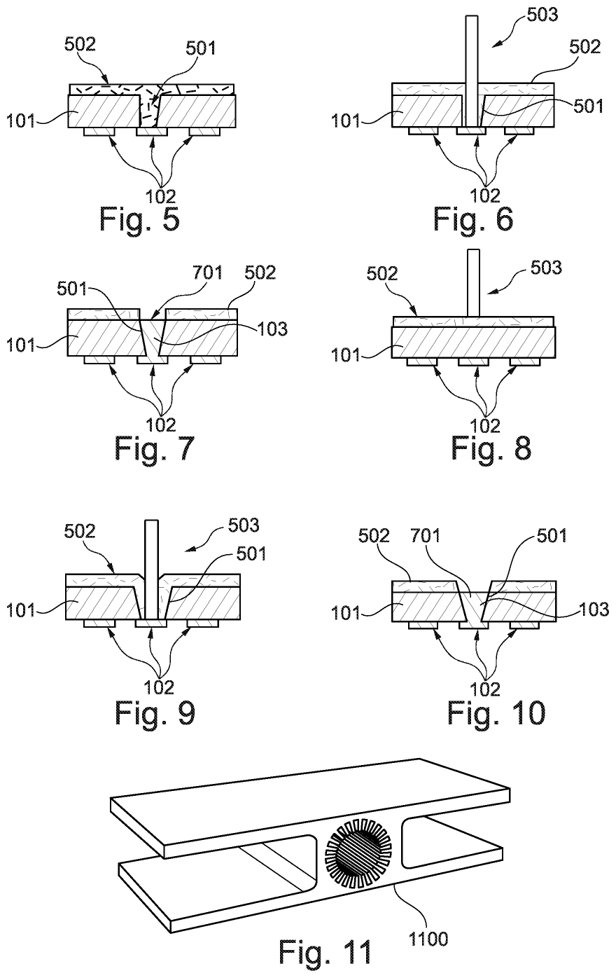

FIG. 8 to FIG. 10 show schematic views of a method of forming a component carrier 100 comprising an electrical contact structure 701 according to an exemplary embodiment of the present invention. Accordingly, the metal surface structure 102 forms an electrical contact element or structure 701, in particular a contact pad, a contact line, or a plated area. The metal body 103 is formed within a contact hole 501 of the carrier body 103, such that the metal body 103 and the metal surface structure 102 forms the electrical contacting structure 701.

The metal surface structure 102 is arranged on a carrier body surface or embedded within the carrier body 101. As can be seen from FIG. 8, the metal surface structure 102 is in registration with the laser beam 503. Next, material (i.e., powder material) 502 suitable for being used with additive manufacturing techniques is filled into the contact hole 501 and onto the metal surface structure by additive manufacturing.

The contact hole 501 in the exemplary embodiment in FIG. 8 is formed by using the laser beam 503 used in, e.g., a SLM/SLS machine to produce the hole 501 through the carrier body 101 and melt the powder bed 502 on top of the PCB 101 at the same time which will fill the hole. The laser device generating the laser beam 503 in, e.g., a SLM/SLS machine can be first used to produce holes 501 and then after filling the hole 501 with the printing material 502 subsequent melting or sintering the printing material 502. Hence, as can be taken from FIG. 9, the laser beam 503 melts or sinters the printing material 502. In FIG. 10 it is shown that after applying the laser beam 503 and hence after solidifying the printing material an electrical contact structure 701 is formed.

FIG. 11 shows a schematic view of a metal body 103 formed as a heat pipe 1100 according to an exemplary embodiment of the present invention. The metal heat pipe 1100 comprises an inner cavity along which an internal cooling fluid is flowable. As can be taken from FIG. 11, cooling fins may be formed inside the inner cavity. The heat pipe 1100 functions as a heat-transfer device for transferring heat away from the component 106 and the metal surface structure 102, respectively.

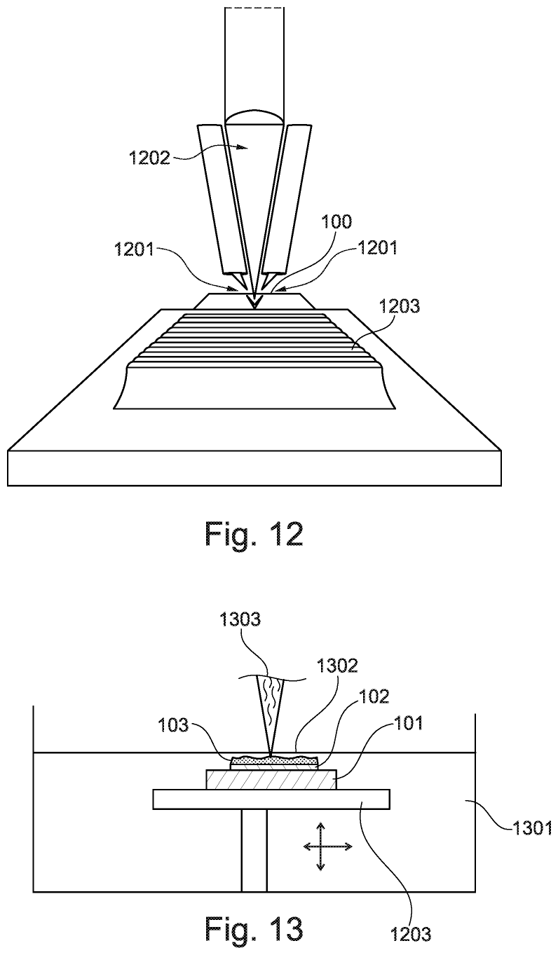

FIG. 12 shows a schematic view of a manufacturing tool for forming a component carrier 100 according to an exemplary embodiment of the present invention.

The component carrier 100 may be arranged onto a moving platform 1203. The moving platform 1203 moves the component carrier 100 along two or three spatial directions with respect to a printer head. The printer head comprises for example material delivery nozzles 1201. A printing material, such as a powder material, may be injected by the material delivery nozzles 1201 to a desired spot onto the metal surface structure 102 and/or a layer of the metal body 103. Simultaneously or subsequently, a laser device 1202 of the printer head focuses a laser beam to the desired spot in order to melt or sinter the printing material.

FIG. 13 shows a schematic view of a manufacturing tool for forming a component carrier according to an exemplary embodiment of the present invention. A fluid material and specifically a powder material suitable for conducting additive manufacturing is filled in a container for providing a fluid bed, in particular material/powder bed 1301. A moving platform 1203 is arranged within the container and is movable at least along one spatial direction, specifically in the direction to a surface of the material bed 1301.

The carrier body 101 is arranged inside the material bed 1301 onto the moving platform 1203. The metal surface structure 102 is formed in or onto the carrier body 101 (for example by additive manufacturing). The metal surface structure 102 is arranged with a defined distance to a surface of the material bed 1301. Hence, between the environment and the metal surface structure 102, a desired thickness of a solidifiable metal body layer 1302 of powder material 1302 is formed. Next, by a treatment device 1303, which may be a thermal treatment device for applying thermal energy to the metal surface structure 102 or for radiating a predefined wavelength of light for photopolymerization to the metal surface structure 102, solidifies the applied printing material between the surface of the material bed 1301 and the metallic surface structure 102.

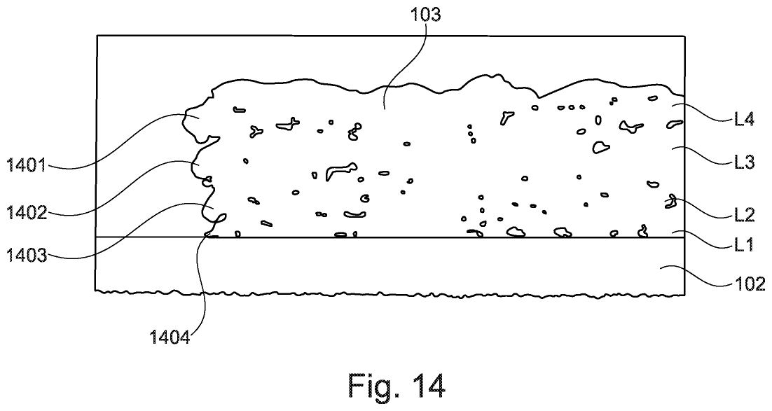

FIG. 14 shows a schematic view of layers L1 to L4 of the metal body 103 formed by 3D-printing as a layer-by-layer additive manufacturing on the metal surface structure 102 according to an exemplary embodiment of the present invention. Thus, the different layers L1 to L4 formed by an additive manufacturing process can be seen in the final product. The different layers L1 to L4 are formed one on top of the other on the metallic surface structure 102. In this example, the layers L1 to L4 are fixed together and may have essentially the same thickness. Thereby, the metal body 103 formed by a 3D printing is unequivocally recognizable as being formed by this technology and is distinguishable from products done with other technologies/processes. The layer-by-layer structure of the metal body 103 is composed of melted material (e.g., copper, copper comprising alloys (having in particular a melting point below 1350° C.) deposited on the metal surface structure 102. At lateral ends of each layer L1 to L4, lateral imperfections and lateral protrusions 1401 to 1402, respectively, are formed by lateral ends of each layer L1 to L4 and respective lateral indentations between the lateral protrusions 1401 to 1404, unequivocally recognizable as manufactured by 3D printing process. Furthermore, the top surface of the 3D printed metal body 103 is rough and comprises protrusions (bumps). Hence, indentations between the protrusions are visible.

Some aspects of the invention are described below.

In a first aspect, a component carrier, comprises: a carrier body formed of a plurality of electrically conductive layer structures and/or electrically insulating layer structures; a metal surface structure coupled to the layer structures; and a metal body directly on the metal surface structure formed by additive manufacturing.

In a second aspect, the component carrier according to the first aspect, wherein the metal body is arranged directly on the metal surface structure without material in between.

In a third aspect, the component carrier according to the first aspect, wherein the metal surface structure comprises a metal foil, in particular a copper foil, wherein the metal body comprises in particular a material selected of at least one of the group consisting of copper, aluminum, silver, nickel, bronze, gold, titanium, tantalum, wolfram, molybdenum and steel.

In a fourth aspect, the component carrier according to the first aspect, wherein the metal body comprises cooling fins, wherein the cooling fins comprise in particular a fractal geometry.

In a fifth aspect, the component carrier according to the first aspect, wherein the metal body is a heat removal body, in particular one of a heat sink, a heat pipe and a tube for forced water flow, wherein the metal body functioning in particular as a heat pipe comprises the tube extending at least partially along the metal surface structure, wherein the tube in particular surrounds at least partially a heat generating component.

In a sixth aspect, the component carrier according to the first aspect, wherein the metal body comprises at least one locally roughened surface which has a higher roughness than other surfaces of the metal body for providing a heat exchange with a cooling medium or enhanced irradiation, wherein in particular the metal surface structure or the metal body forms an electrical contact element, in particular a contact pad, a contact line, or a plated area, wherein the metal body is formed in particular within a contact hole of the carrier body, such that the metal body and the metal surface structure form an electrical and/or thermal contact structure, wherein the carrier body comprises in particular a through hole between a first body surface and a second body surface of the carrier body, wherein the metal surface structure is formed within the through hole such that a first surface of the metal surface structure is accessible in particular for an electronic component, and a second surface of the metal surface structure opposite to the first surface is in contact with the metal body.

In a seventh aspect the component carrier according to the first aspect, further comprising: a component, in particular an electronic component, mounted on and/or embedded in the carrier body, wherein the component is in particular thermally coupled via the metal surface structure to the metal body, wherein the component is attached in particular to a carrier body surface of the carrier body, wherein the metal surface structure is in particular formed between the carrier body surface and the component for providing a thermal connection, wherein the carrier body surface in particular comprises a receiving recess within the component is arranged, wherein the metal surface structure is in particular formed by a metal surface of the component.

In an eighth aspect the component carrier according to the seventh aspect, wherein the component is embedded in the carrier body and is thermally coupled via the metal surface structure to the metal body, wherein the carrier body in particular comprises an internal receiving cavity into which the component is embedded, wherein at least one of the plurality of electrically conductive layer structures and/or electrically insulating layer structures is arranged between a surface of the metal body and the receiving cavity, wherein at least one channel is formed in the at least one of the plurality of electrically conductive layer structures and/or electrically insulating layer structures between the receiving cavity and the surface of the metal body arranged on a surface of the carrier body, wherein the at least one channel is filled with at least a part of the metal surface structure, wherein the component is in particular selected from a group consisting of an electronic component, an electrically non-conductive and/or electrically conductive inlay, a heat transfer unit, a light guiding element, an energy harvesting unit, an active electronic component, a passive electronic component, an electronic chip, a storage device, a filter, an integrated circuit, a signal processing component, a power management component, an optoelectronic interface element, a voltage converter, a cryptographic component, a transmitter and/or receiver, an electromechanical transducer, an actuator, a microelectromechanical system, a microprocessor, a capacitor, a resistor, an inductance, an accumulator, a switch, a camera, an antenna, a magnetic element, a further component carrier and a logic chip, wherein in particular the at least one electrically conductive layer structure comprises at least one of the group consisting of copper, aluminum, nickel, silver, gold, palladium, and tungsten, any of the mentioned materials being optionally coated with supra-conductive material such as graphene.

In a ninth aspect the component carrier according to the first aspect, wherein the at least one electrically insulating layer structure comprises at least one of the group consisting of resin, in particular reinforced or non-reinforced resin, for instance epoxy resin or Bismaleimide-Triazine resin, FR-4, FR-5, cyanate ester, polyphenylene derivate, glass, prepreg material, polyimide, polyamide, liquid crystal polymer, epoxy-based Build-Up Film, polytetrafluoroethylene, a ceramic, and a metal oxide, wherein the component carrier is in particular shaped as a plate, wherein the component carrier is in particular configured as one of the group consisting of a printed circuit board, and a substrate, wherein the component carrier is configured in particular as a laminate-type component carrier.

A tenth aspect includes a method of manufacturing a component carrier, wherein the method comprises: connecting a stack of a plurality of electrically conductive layer structures and/or electrically insulating layer structures for forming a carrier body; forming a metal surface structure coupled to the layer structures; and forming a metal body directly on the metal surface structure by additive manufacturing.

In an eleventh aspect the method according to the tenth aspect, wherein the additive manufacturing comprises: applying a printing material to an application device, melting the printing material in the application device, and applying the melted printing material on the metal surface structure for forming at least one layer of the metal body.

In a twelfth aspect the method according to the tenth aspect, wherein the additive manufacturing comprises: applying a printing material, in particular a powder material, on the metal surface structure, consolidating the applied printing material for forming at least one layer of the metal body, wherein the at least one layer of the metal body is in particular formed by at least one of the group consisting of selective laser melting, selective laser sintering, and electron beam melting, wherein in particular before consolidating the printing material, the printing material is melted by a thermal treatment device, in particular a laser device, wherein in particular the printing material is applied by a material delivery nozzle.

In a thirteenth aspect the method according to the twelfth aspect further including moving the material delivery nozzle for forming a further layer of the metal body.

In a fourteenth aspect the method according to the twelfth aspect wherein before the printing material is applied on the metal surface, the carrier body is moved into a material bed consisting of the printing material, wherein the method in particular further comprises moving the carrier body for forming a further layer of the metal body.

In a fifteenth aspect the method according to the tenth aspect, wherein the carrier body is arranged in a container, wherein the additive manufacturing comprises: providing a solidifiable fluid material in the container, solidifying the fluid material by a treatment device, in particular a laser device, on the metal surface for forming at least one layer of the metal body, wherein the fluid material is in particular a photosensitive material wherein the method in particular further comprises: moving the carrier body for forming a further layer of the metal body.

It should be noted that the term “comprising” does not exclude other elements or steps and the article “a” or “an” does not exclude a plurality. Also, elements described in association with different embodiments may be combined.

Implementation of the disclosure is not limited to the embodiments illustrated in the figures and described above. Instead, a multiplicity of variants is possible which variants use the solutions shown and the principle according to the disclosure even in the case of fundamentally different embodiments.

### LIST OF REFERENCE SIGNS

100 component carrier
101 carrier body
102 metal surface structure
103 metal body
104 cooling fins
105 through hole
106 component
107 conductive pads/lines
201 internal receiving cavity
202 channel
401 receiving recess
501 hole
502 printing/powder material
503 laser beam
701 electrical contact structure
1100 heat pipe
1201 material/powder delivery nozzle
1202 laser device
1203 moving platform
1301 material/powder bed
1302 solidifiable metal body layer
1303 treatment device
1401-1404 lateral protrusions
L1 to L4 layers of the metal body

1. A component carrier, wherein the component carrier comprises:
a carrier body formed of a plurality of electrically conductive layer structures and/or electrically insulating layer structures;
a metal surface structure coupled to the layer structures; and
a metal body directly on the metal surface structure formed by additive manufacturing,
wherein the metal body is arranged directly on the metal surface structure without material and layers in between.

2. The component carrier according to claim 1,
wherein the additive manufacturing is accomplished by 3D-printing.

3. The component carrier according to claim 2,
wherein the metal body is formed layer-by-layer.

4. The component carrier according to claim 1,
wherein the metal body is configured as a heat transfer body.

5. The component carrier according to claim 1,
wherein the metal body is configured as a heat sink.

6. The component carrier according to claim 5,
wherein an interface between the heat sink and the metal surface structure is continuous and homogeneous, so that no gaps or cavities are formed along the interface.

7. The component carrier according to claim 1, comprising at least one of the following features:
wherein the metal surface structure comprises a metal foil, in particular a copper foil;
wherein the metal body comprises a material selected of at least one of the group consisting of copper, aluminum, silver, nickel, bronze, gold, titanium, tantalum, wolfram, molybdenum and steel;
wherein the metal body comprises cooling fins;
wherein the cooling fins comprise a fractal geometry;
wherein the metal body is a heat removal body, in particular one of a heat sink, a heat pipe and a tube for forced water flow;
wherein the metal body functioning as a heat pipe comprises the tube extending at least partially along the metal surface structure;
wherein the tube surrounds at least partially a heat generating component;
wherein the metal body comprises at least one locally roughened surface which has a higher roughness than other surfaces of the metal body for providing a heat exchange with a cooling medium or enhanced irradiation;
wherein the metal surface structure or the metal body forms an electrical contact element, in particular a contact pad, a contact line or a plated area;
wherein the metal body is formed within a contact hole of the carrier body, such that the metal body and the metal surface structure form an electrical and/or thermal contact structure;
wherein the carrier body comprises a through hole between a first body surface and a second body surface of the carrier body,
wherein the metal surface structure is formed within the through hole such that
a first surface of the metal surface structure is accessible in particular for an electronic component, and
a second surface of the metal surface structure opposite to the first surface is in contact with the metal body.

8. The component carrier according to claim 1, further comprising at least one of the following features:
a component, in particular an electronic component, mounted on and/or embedded in the carrier body;
wherein the component is thermally coupled via the metal surface structure to the metal body;
wherein the component is attached to a carrier body surface of the carrier body;
wherein the metal surface structure is formed between the carrier body surface and the component for providing a thermal connection;
wherein the carrier body surface comprises a receiving recess within the component is arranged;
wherein the metal surface structure is formed by a metal surface of the component.

9. The component carrier according to claim 8, further comprising at least one of the following features:
wherein the component is embedded in the carrier body and being thermally coupled via the metal surface structure to the metal body;
wherein the carrier body comprises an internal receiving cavity into which the component is embedded;
wherein at least one of the plurality of electrically conductive layer structures and/or electrically insulating layer structures is arranged between a surface of the metal body and the receiving cavity;
wherein at least one channel is formed in the at least one of the plurality of electrically conductive layer structures and/or electrically insulating layer structures between the receiving cavity and the surface of the metal body arranged on a surface of the carrier body;
wherein the at least one channel is filled with at least a part of the metal surface structure;
wherein the component is selected from a group consisting of an electronic component, an electrically non-conductive and/or electrically conductive inlay, a heat transfer unit, a light guiding element, an energy harvesting unit, an active electronic component, a passive electronic component, an electronic chip, a storage device, a filter, an integrated circuit, a signal processing component, a power management component, an optoelectronic interface element, a voltage converter, a cryptographic component, a transmitter and/or receiver, an electromechanical transducer, an actuator, a microelectromechanical system, a microprocessor, a capacitor, a resistor, an inductance, an accumulator, a switch, a camera, an antenna, a magnetic element, a further component carrier and a logic chip, wherein in particular the at least one electrically conductive layer structure comprises at least one of the group consisting of copper, aluminum, nickel, silver, gold, palladium, and tungsten, any of the mentioned materials being optionally coated with supra-conductive material such as graphene.

10. The component carrier according to claim 1,
wherein the at least one electrically insulating layer structure comprises at least one of the group consisting of resin, in particular reinforced or non-reinforced resin, for instance epoxy resin or Bismaleimide-Triazine resin, FR-4, FR-5, cyanate ester, polyphenylene derivate, glass, prepreg material, polyimide, polyamide, liquid crystal polymer, epoxy-based Build-Up Film, polytetrafluoroethylene, a ceramic, and a metal oxide,
wherein the component carrier is in particular shaped as a plate,
wherein the component carrier is in particular configured as one of the group consisting of a printed circuit board, and a substrate, wherein the component carrier is configured in particular as a laminate-type component carrier.

11. A method of manufacturing a component carrier, wherein the method comprises:
connecting a stack of a plurality of electrically conductive layer structures and/or electrically insulating layer structures for forming a carrier body;
forming a metal surface structure coupled to the layer structures;
forming a metal body directly on the metal surface structure by additive manufacturing; and
arranging the metal body directly on the metal surface structure without material and layers in between.

12. The method according to claim 11, wherein the additive manufacturing comprises:
applying a printing material to an application device,
melting the printing material in the application device,
applying the melted printing material on the metal surface structure for forming at least one layer of the metal body.

13. The method according to claim 11, wherein the additive manufacturing comprises:
applying a printing material, in particular a powder material, on the metal surface structure,
consolidating the applied printing material for forming at least one layer of the metal body.
wherein the at least one layer of the metal body is in particular formed by at least one of the group consisting of selective laser melting, selective laser sintering, and electron beam melting,
wherein in particular before consolidating the printing material, the printing material is melted by a thermal treatment device, in particular a laser device,
wherein in particular the printing material is applied by a material delivery nozzle.

14. The method according to claim 13, comprising at least one of the following features:
wherein the additive manufacturing further comprises moving the material delivery nozzle for forming a further layer of the metal body;
wherein before the printing material is applied on the metal surface, the carrier body is moved into a material bed consisting of the printing material,
wherein the method in particular further comprises moving the carrier body for forming a further layer of the metal body.

15. The method according to claim 11,
wherein the carrier body is arranged in a container,
wherein the additive manufacturing comprises:
providing a solidifiable fluid material in the container,
solidifying the fluid material by a treatment device, in particular a laser device, on the metal surface for forming at least one layer of the metal body,
wherein the fluid material is in particular a photosensitive material wherein the method in particular further comprises moving the carrier body for forming a further layer of the metal body.
